(19) United States
(12) Patent Application Publication
(10) Pub. No.: US 2018/0039012 A1
(43) Pub. Date: Feb. 8, 2018

(54) DISPLAY DEVICE

(71) Applicant: Samsung Display Co., Ltd., Yongin-Si (KR)

(72) Inventors: Ho-sik SHIN, Gunpo-si (KR); Hayoung LEE, Seoul (KR); Kyung-min KIM, Hwaseong-si (KR); Sehee JEON, Seoul (KR)

(21) Appl. No.: 15/646,669

(22) Filed: Jul. 11, 2017

(30) Foreign Application Priority Data
Aug. 8, 2016 (KR) 10-2016-0100901

(51) Int. Cl. F21V 8/00; G02F 1/1333; G02F 1/1335

(52) U.S. Cl. CPC G02B 6/0056; G02B 6/005; G02B 6/0068; G02B 6/002; G02F 1/13362; G02F 1/133528; G02F 1/133377; G02B 6/0043; G02F 2001/133614; G02F 2202/36; G02F 1/133514; G02F 1/133512; G02B 6/0055

(57) ABSTRACT

A display device includes a display module, a light guide plate, a light source disposed at a side of the light guide plate in a first direction, the light source including light source units arranged in a second direction, and a condensing sheet including reverse prisms. The display module includes first and second polarizing plates facing each other, a display unit including a liquid crystal layer, and a light-conversion structure. In a plan view, the light source units include first and second light source units, which are parallel to third and fourth directions, respectively. The third and fourth directions are at angles of +45° and −45° to the first direction. Each reverse prism includes a base surface that is parallel to the plane and includes two sides parallel to the third and fourth directions, respectively.

This application claims priority to Korean Patent Application No. 10-2016-0100901, filed on Aug. 8, 2016, and all the benefits accruing therefrom under 35 U.S.C. §119, the content of which in its entirety is herein incorporated by reference.

### BACKGROUND

### 1. Field

Exemplary embodiments of the invention relate to a display device, and in particular, to a display device with an improved contrast ratio in a dark state.

### 2. Description of the Related Art

An electronic product, such as a mobile communication terminal, a digital camera, a notebook computer, a monitor, and a television set, has a display device which displays an image.

In general, the display device includes a display panel for providing an image and a backlight unit (“BLU”) for providing light to the display panel. In the display panel, transmittance of light provided from the backlight unit is controlled to display an image.

The BLU may be classified into two categories including an edge-type BLU supplying light to a side surface a display panel and a direct-type BLU supplying light to a display panel through a bottom surface of the display panel. The edge-type backlight unit has a light source, which is used to generate light, and a light guide plate, which is used to guide a propagation direction of the light. The light source is disposed at a side of the light guide plate, and the light guide plate is used to guide the light, which is generated from the light source, to the display panel.

### SUMMARY

Exemplary embodiments of the invention provide a display device with an improved contrast ratio in a dark state.

According to exemplary embodiments of the invention, a display device may include a display module which displays an image, a light guide plate disposed below the display module, a light source disposed at a side of the light guide plate in a first direction, the light source including a plurality of light source units arranged in a second direction crossing the first direction, and a condensing sheet disposed between the display module and the light guide plate, the condensing sheet including a plurality of reverse prisms. The display module may include a first polarizing plate disposed on the condensing sheet, a second polarizing plate facing the first polarizing plate, a display unit disposed between the first and second polarizing plates, the display unit including a liquid crystal layer, and a light-conversion structure disposed on the second polarizing plate. The plurality of light source units may include a plurality of first light source units parallel to a third direction, which is at an angle of +45° to the first direction, when viewed on a plane defined by the first and second directions, and a plurality of second light source units parallel to a fourth direction, which is at an angle of −45° to the first direction, when viewed on the plane. Each of the reverse prisms may include a base surface, which is parallel to the plane, and a plurality of inclined surfaces, which are inclined at an angle with reference to the base surface, and the base surface may include corners, each of which is defined by two sides parallel to the third and fourth directions, respectively.

In an exemplary embodiment, the light guide plate may include a light entering portion disposed at a side of the light guide plate in the first direction to receive light from the light source, an opposite portion facing the light entering portion in the first direction, a light emitting portion which is parallel to the plane and emits light, which is incident from the light entering portion, in an upward direction, and a bottom portion facing the light emitting portion and including a plurality of dot patterns.

In an exemplary embodiment, the light entering portion may include a plurality of first light entering surfaces parallel to the third direction, and a plurality of second light entering surfaces parallel to the fourth direction.

In an exemplary embodiment, the light guide plate may include a first portion disposed at a side of the light guide plate in the second direction to receive light from the plurality of first light source units, and a second portion disposed at another side of the light guide plate in the second direction to receive light from the plurality of second light source units.

In an exemplary embodiment, when viewed in the first direction, the first portion may include a first light entering portion disposed at an off-centered region of the first portion and the second portion includes a second light entering portion disposed at an off-centered region of the second portion.

In an exemplary embodiment, the first light entering portion includes: a plurality of first light entering surfaces parallel to the third direction and face the plurality of first light source units, and a plurality of first connection surfaces connecting the first light entering surfaces. The second light entering portion may include a plurality of second light entering surfaces parallel to the fourth direction and face the plurality of second light source units, and a plurality of second connection surfaces connecting the second light entering surfaces.

In an exemplary embodiment, the light-conversion structure may include a plurality of quantum dots (“QDs”).

In an exemplary embodiment, the display unit may further include a first substrate disposed on the first polarizing plate and a second substrate disposed below the second polarizing plate. The liquid crystal layer may be interposed between the first and second substrates.

In an exemplary embodiment, the display unit may further include a first substrate disposed on the first polarizing plate and a cover layer disposed on the first substrate. The cover layer may be slightly spaced apart from the first substrate to provide a plurality of cavities. The liquid crystal layer may be disposed in each of the plurality of cavities.

In an exemplary embodiment, the display unit may further include a first substrate disposed on the first polarizing plate and a second substrate disposed on the second polarizing plate. The liquid crystal layer may be interposed between the first substrate and the second polarizing plate.

In an exemplary embodiment, the plurality of dot patterns may have a convex shape protruding from the bottom portion.

In an exemplary embodiment, the plurality of dot patterns may have a concave shape recessed upward from the bottom portion.

In an exemplary embodiment, the light source may further include a light source substrate, on which the plurality of light source units are disposed.

In an exemplary embodiment, the light source substrate extends in the second direction and may be parallel to a plane defined by the first and second directions.

In an exemplary embodiment, the reverse prisms may include a first prism group of reverse prisms, which are arranged in a line in the third direction, and a second prism group of reverse prisms, which are adjacent to the first prism group in the fourth direction and are arranged in a line in the third direction. The reverse prisms of the first prism group may be shifted from the reverse prisms of the second prism group in the third direction by a first distance, and the first distance may be different from a length of the base surface measured in the third direction.

In an exemplary embodiment, the reverse prisms may include a first prism group of reverse prisms, which are arranged in a line in the fourth direction, and a second prism group of reverse prisms, which are adjacent to the first prism group in the third direction and are arranged in a line in the fourth direction. The reverse prisms of the first prism group may be shifted from the reverse prisms of the second prism group in the fourth direction by a second distance, and the second distance may be different from a length of the base surface measured in the fourth direction.

According to exemplary embodiments of the invention, a display device may include a display module which displays an image, a light guide plate disposed below the display module, a light source disposed at a side of the light guide plate in a first direction, the light source extending in a second direction crossing the first direction and providing light to the light guide plate, and a condensing sheet disposed between the display module and the light guide plate. The condensing sheet may include a plurality of reverse prisms. The display module may include a display unit including a liquid crystal layer, a light-conversion structure disposed on the display unit to change a wavelength of light, which is incident from the display unit, a first polarizing plate disposed between the display unit and the condensing sheet, and a second polarizing plate disposed between the display unit and the light-conversion structure. The light source may include first light source units, which are tilted in a third direction, on a plane defined by the first and second directions, where the third direction is a direction between the first and second directions. Each of the reverse prisms may include a base surface, which is parallel to the plane, and a plurality of inclined surfaces, which are inclined at an angle with reference to the base surface, and the base surface may include sides parallel to the third direction.

In an exemplary embodiment, the third direction may be at an angle of 45° or −45° relative to the first direction.

In an exemplary embodiment, the light guide plate may include a light entering portion which is disposed at a side of the light guide plate in the first direction and receives light from the light source, and an opposite portion facing the light entering portion in the first direction, a light emitting portion which is parallel to the plane and emits light, which is incident from the light entering portion, in an upward direction, and a bottom portion facing the light emitting portion and including a plurality of dot patterns.

In an exemplary embodiment, the light-conversion structure may include a plurality of QDs.

### BRIEF DESCRIPTION OF THE DRAWINGS

Exemplary embodiments will be more clearly understood from the following brief description taken in conjunction with the accompanying drawings, in which:

FIG. 1 is an exploded perspective view illustrating an exemplary embodiment of a display device according to the invention.

FIG. 2 is a sectional view taken along line I-I′ of FIG. 1;

FIG. 3 is an enlarged sectional view of the display module of FIG. 2;

FIG. 4A is a top-plan view of an exemplary embodiment of a light guide plate according to the invention;

FIG. 4B is a bottom-plan view of an exemplary embodiment of a light guide plate according to the invention;

FIG. 5 is a top-plan view illustrating an exemplary embodiment of a light source and a light guide plate according to the invention;

FIG. 6 is a perspective view of the light source of FIG. 5;

FIG. 7 is a perspective view illustrating an exemplary embodiment of a bottom side of a condensing sheet according to the invention;

FIG. 8 is a bottom-plan view illustrating an exemplary embodiment of a condensing sheet according to the invention;

FIG. 9A is an enlarged perspective view of the reverse prism of FIG. 7;

FIG. 9B is a top-plan view of the reverse prism of FIG. 7;

FIG. 9C is a bottom-plan view of the reverse prism of FIG. 7;

FIG. 10 is a diagram illustrating an exemplary embodiment of a light propagation state when a display device according to the invention is in a dark state;

FIG. 11 is an enlarged view of another exemplary embodiment of a display module according to the invention;

FIG. 12 is a sectional view of another exemplary embodiment of a display device according to the invention;

FIG. 13 is a top-plan view of another exemplary embodiment of a light source and a light guide plate according to the invention;

FIG. 14 is a perspective view of a light source of FIG. 13.

FIG. 15 is a bottom-plan view of another exemplary embodiment of a condensing sheet according to the invention;

FIG. 16 is an enlarged view of a condensing sheet of FIG. 15.

FIG. 17 is a bottom-plan view of an exemplary embodiment of a condensing sheet according to the invention; and

FIG. 18 is an enlarged view of a condensing sheet of FIG. 17.

### DETAILED DESCRIPTION

Exemplary embodiments of the invention will now be described more fully with reference to the accompanying drawings, in which exemplary embodiments are shown. Exemplary embodiments of the inventive concepts may, however, be embodied in many different forms and should not be construed as being limited to the embodiments set forth herein; rather, these embodiments are provided so that this disclosure will be thorough and complete, and will fully convey the concept of exemplary embodiments to those of ordinary skill in the art. In the drawings, the thicknesses of layers and regions are exaggerated for clarity. Like reference numerals in the drawings denote like elements, and thus their description will be omitted.

It should be noted that these drawings are intended to illustrate the general characteristics of methods, structure and/or materials utilized in certain exemplary embodiments and to supplement the written description provided below. These drawings are not, however, to scale and may not precisely reflect the precise structural or performance characteristics of any given embodiment, and should not be interpreted as defining or limiting the range of values or properties encompassed by exemplary embodiments. In an exemplary embodiment, the relative thicknesses and positioning of molecules, layers, regions and/or structural elements may be reduced or exaggerated for clarity. The use of similar or identical reference numbers in the various drawings is intended to indicate the presence of a similar or identical element or feature.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Like numbers indicate like elements throughout. As used herein the term “and/or” includes any and all combinations of one or more of the associated listed items. Other words used to describe the relationship between elements or layers should be interpreted in a like fashion (e.g., “between” versus “directly between,” “adjacent” versus “directly adjacent,” “on” versus “directly on”).

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the drawings. It will be understood that the spatially relative terms are intended to encompass different orientations of the device in use or operation in addition to the orientation depicted in the drawings. For example, if the device in the drawings is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of exemplary embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Exemplary embodiments of the inventive concepts are described herein with reference to cross-sectional illustrations that are schematic illustrations of idealized embodiments (and intermediate structures) of exemplary embodiments. As such, variations from the shapes of the illustrations as a result, for example, of manufacturing techniques and/or tolerances, are to be expected. Thus, exemplary embodiments of the inventive concepts should not be construed as limited to the particular shapes of regions illustrated herein but are to include deviations in shapes that result, for example, from manufacturing. For example, an implanted region illustrated as a rectangle may have rounded or curved features and/or a gradient of implant concentration at its edges rather than a binary change from implanted to non-implanted region.

Unless otherwise defined, all terms (including technical and scientific terms) used herein have the same meaning as commonly understood by one of ordinary skill in the art to which exemplary embodiments of the inventive concepts belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

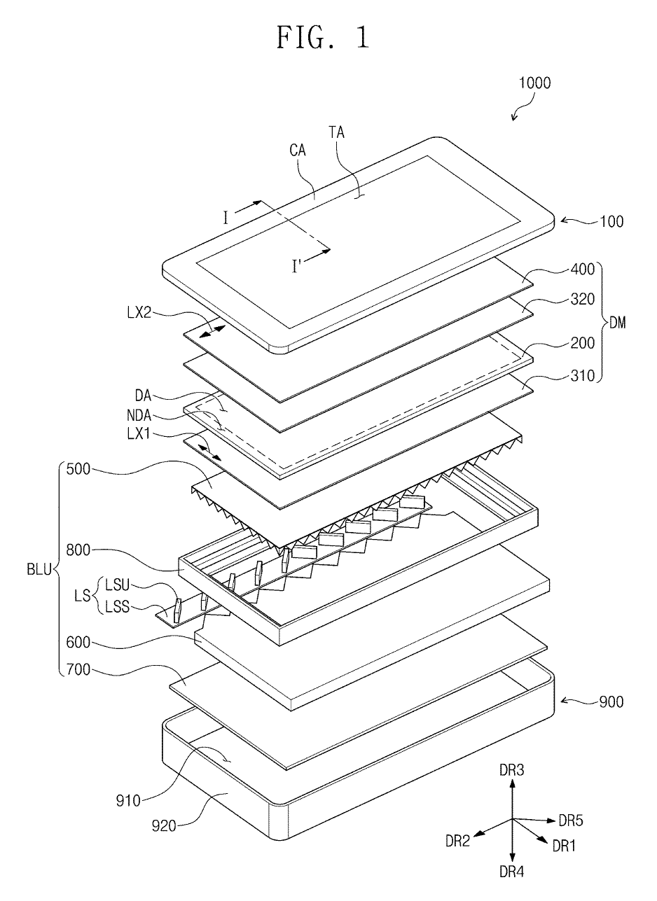

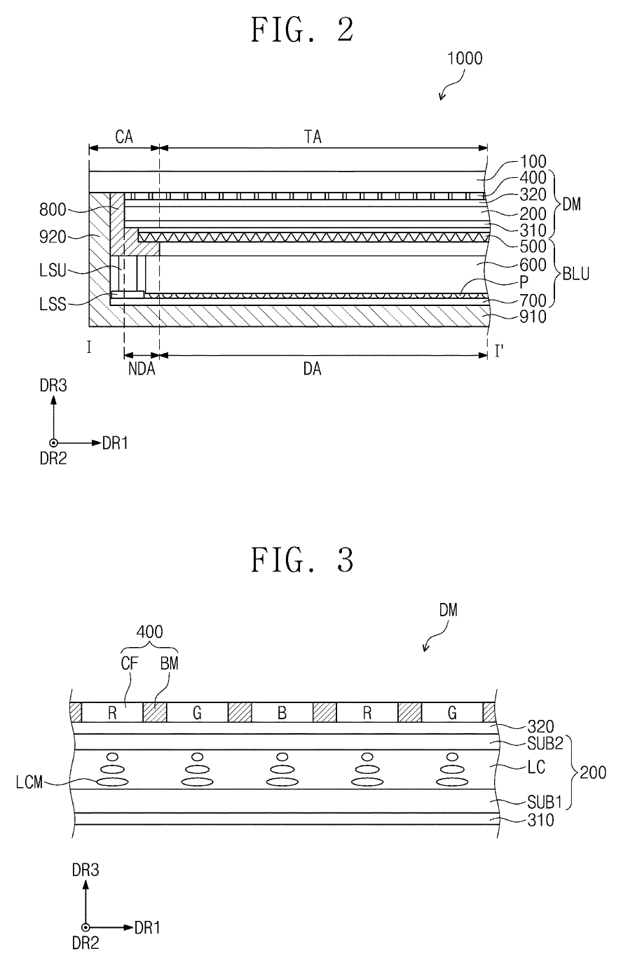

FIG. 1 is an exploded perspective view illustrating a display device according to an exemplary embodiment of the invention, and FIG. 2 is a sectional view taken along line I-I′ of FIG. 1.

Referring to FIGS. 1 and 2, a display device 1000 may be a rectangular structure having short and long sides that are parallel to first and second directions DR1 and DR2, respectively. However, the invention is not limited thereto, and in other exemplary embodiments, the shape of the display device 1000 may be variously changed.

The display device 1000 may include a window unit 100, a display module DM, a backlight unit BLU, a mold frame 800, and a container 900.

The window unit 100 may include a light-transmitting region TA, which allows light of an image provided from the display module DM to pass therethrough, and a light-blocking portion CA, which is adjacent to the light-transmitting region TA and prevents the light of the image from passing therethrough. In a plan view, the light-transmitting region TA may be disposed in a center region of the display device 1000. The light-blocking portion CA may be provided around the light-transmitting region TA and may have a frame shape surrounding the light-transmitting region TA.

However, the invention is not limited thereto, and in other exemplary embodiments, the window unit 100 of the display device 1000 may have only the light-transmitting region TA. That is, the light-blocking portion CA may be omitted. Thus, the entire top surface of the window unit 100 may be used to display an image, for example.

In an exemplary embodiment, the window unit 100 may consist of or include at least one of glass, sapphire, or plastic materials, for example.

The display module DM may be provided below the window unit 100. The display module DM may display an image using light to be provided from the backlight unit BLU.

The display module DM may include a display unit 200, a first polarizing plate 310, a second polarizing plate 320, and a light-conversion structure 400.

In a plan view facing a plane parallel to the first and second directions DR1 and DR2, the display unit 200 may include a display region DA and a non-display region NDA. In the plan view, the display region DA may be provided at a center region of the display unit 200 and may overlap the light-transmitting region TA of the window unit 100. The non-display region NDA may enclose the display region DA and may overlap the light-blocking portion CA of the window unit 100.

The display unit 200 may include a plurality of pixels (not shown) provided on the display region DA. The display region DA may be used to display an image of the display unit 200. The display unit 200 may include an optically anisotropic material. The display unit 200 will be described in further detail with reference to FIG. 3.

The first polarizing plate 310 may face the second polarizing plate 320 and the display unit 200 may be provided between the first and second polarizing plates 310 and 320. In an exemplary embodiment, the first polarizing plate 310 may be provided between the display unit 200 and the backlight unit BLU, and the second polarizing plate 320 may be provided between the display unit 200 and the window unit 100, for example.

The first and second polarizing plates 310 and 320 may be used to selectively realize absorption or transmission of an incident light. The first and second polarizing plates 310 and 320 may have respective optic axes which may be different from each other. In an exemplary embodiment, the first polarizing plate 310 may have a first optic axis LX1, and the second polarizing plate 320 may have a second optic axis LX2, for example. An angle between the first and second optic axes LX1 and LX2 may be changed depending on an orientation mode of liquid crystal molecules in the display unit 200.

In an exemplary embodiment, the first and second optic axes LX1 and LX2 may be orthogonal to each other. In an exemplary embodiment, the first optic axis LX1 may be parallel to the first direction DR1, and the second optic axis LX2 may be parallel to the second direction DR2, for example. In another exemplary embodiment, the first optic axis LX1 may be parallel to the second optic axis LX2, for example.

This may be an example of the first and second optic axes LX1 and LX2, and in other exemplary embodiments, the first and second optic axes LX1 and LX2 may be changed from the above example. This will be described in further detail below.

The light-conversion structure 400 may be provided between the second polarizing plate 320 and the window unit 100. The light-conversion structure 400 may change a wavelength of light passing through the second polarizing plate 320. In exemplary embodiments, in the light-conversion structure 400, the light may be changed to have various wavelengths (i.e., various colors).

Although not shown, the light-conversion structure 400 may include light-conversion particles. In an exemplary embodiment, each of the light-conversion particles may be a quantum dot. This will be described in further detail below, for example.

In the exemplary embodiment, the light-conversion structure 400 may be provided in the form of a sheet. However, the invention is not limited to a specific form of the light-conversion structure 400. In other exemplary embodiments, the light-conversion structure 400 may be printed on the second polarizing plate 320 using an inkjet printing method or may be patterned on the second polarizing plate 320 using a depositing method, for example.

The backlight unit BLU may be provided at a back of the display module DM and may be used to provide light to the display module DM. In the illustrated exemplary embodiments, the backlight unit BLU may be an edge-type backlight unit, for example.

The backlight unit BLU may include a light source LS, a condensing sheet 500, a light guide plate 600, and a reflection sheet 700.

The light source LS may generate light to be provided to the display module DM and to provide the light to the light guide plate 600. In the illustrated exemplary embodiments, the light source LS may be provided at a side of the light guide plate 600 in the first direction DR1. However, the invention is not limited to a specific position of the light source LS. In an exemplary embodiment, the light source LS may be provided adjacent to at least one of side surfaces of the light guide plate 600, for example.

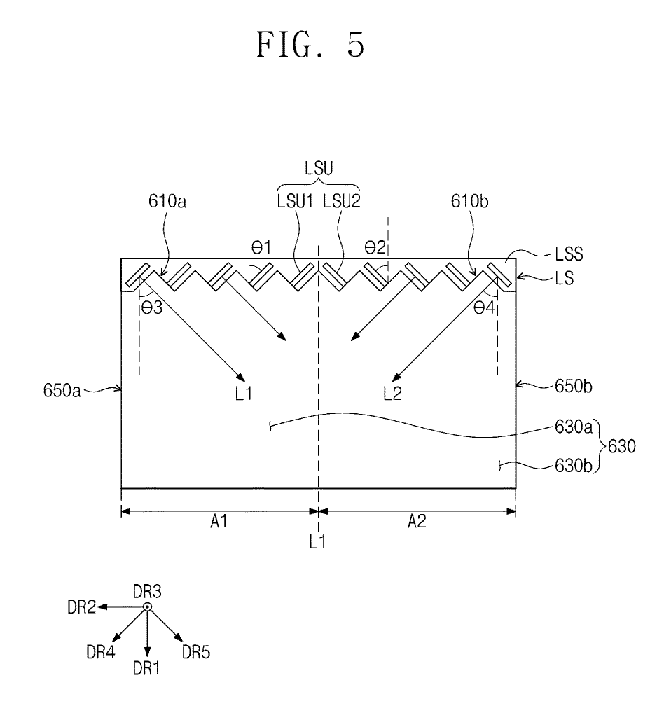

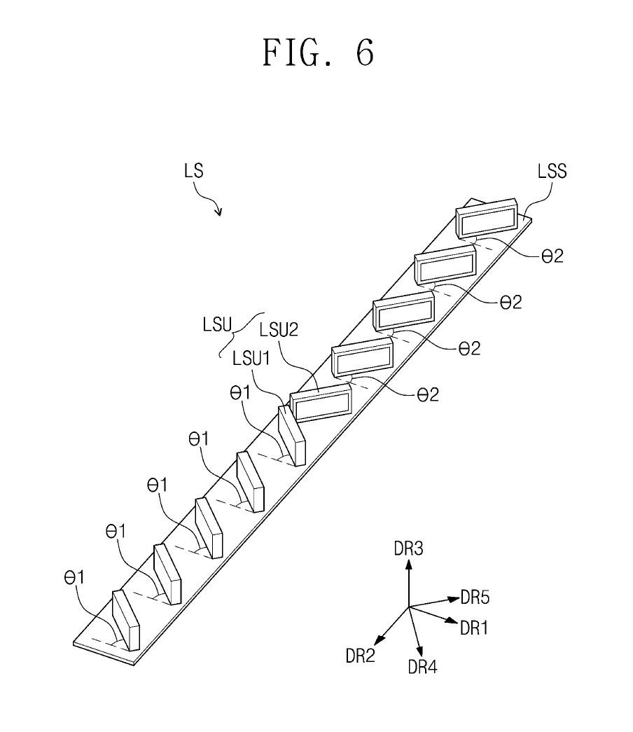

The light source LS may include a plurality of light source units LSU and a light source substrate LSS. This will be described in further detail with reference to FIGS. 5 and 6.

The light guide plate 600 may be provided at the back of the display module DM. The light guide plate 600 may be provided in the form of a plate. The light guide plate 600 may propagate light, which is provided from the light source LS, toward the display module DM or in an upward direction.

The light guide plate 600 may include a plurality of dot patterns P that are provided on a bottom surface of the light guide plate 600. The dot pattern P may have a structure protruding downward from the bottom surface of the light guide plate 600. The dot pattern P may cause scattering of light to be incident into the light guide plate 600. In the case where light from the light source LS is incident into the light guide plate 600, the light may be scattered by the dot pattern P and may be emitted outward from the light guide plate 600.

In the illustrated exemplary embodiments, the dot pattern P may be provided on the bottom surface of the light guide plate 600, but the invention is not limited thereto. In another exemplary embodiment, a pattern, which is shaped like a lens or a groove, may be provided on a top surface of the light guide plate 600, for example.

The light guide plate 600 may consist of or include a material having high transmittance to visible light. In an exemplary embodiment, the light guide plate 600 may consist of or include polymethylmethacrylate (“PMMA”), for example.

The condensing sheet 500 may be provided between the light guide plate 600 and the display module DM. The condensing sheet 500 may condense the light to be incident from the light guide plate 600 and then to provide the condensed light to the display module DM.

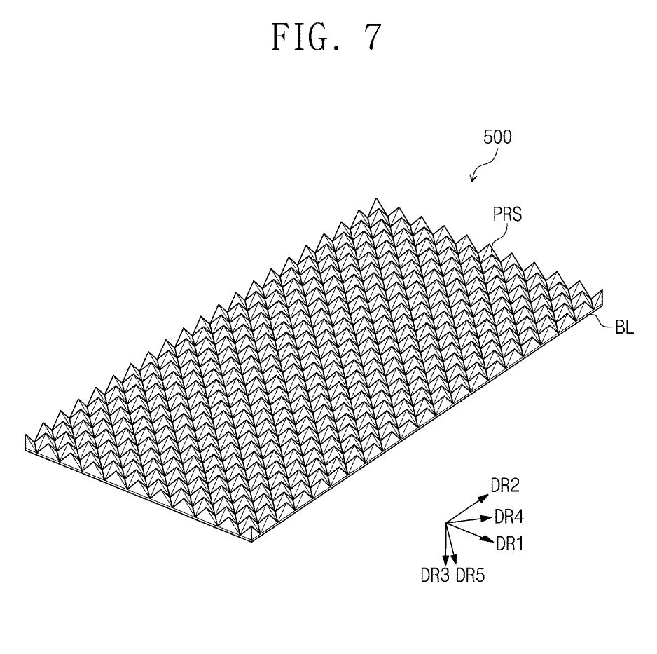

The condensing sheet 500 may include a plurality of reverse prisms (not shown). This will be described in further detail with reference to FIGS. 7 to 9C.

Although not shown, the backlight unit BLU may further include at least one optical sheet (not shown). The optical sheet may be provided on or under the condensing sheet 500. The optical sheet may be a diffusion sheet or a protection sheet.

The reflection sheet 700 may be provided below the light guide plate 600. The reflection sheet 700 may reflect light, which is emitted downward from the light guide plate 600, in an upper direction. The reflection sheet 700 may consist of or include an optically reflective material. In an exemplary embodiment, the reflection sheet 700 may include aluminum, for example.

The mold frame 800 may be provided on the light guide plate 600. In the illustrated exemplary embodiments, the mold frame 800 may include a portion that is provided in the form of a frame. In an exemplary embodiment, the frame-shaped portion of the mold frame 800 may have a shape corresponding to an edge region of the top surface of the light guide plate 600, for example. The mold frame 800 may be used to immobilize the display unit 200 and the backlight unit BLU.

The mold frame 800 may have a stepwise section. In an exemplary embodiment, a mold frame 800 may include a plurality of flat portions located within the frame-shaped portion of the mold frame 800, for example. Each of the flat portions may extend parallel to a plane, which is defined by the first and second directions DR1 and DR2, and may have a height difference from another of the flat portions.

The display module DM and the condensing sheet 500 may be disposed on the flat portions of the mold frame 800. In exemplary embodiments, owing to the height difference of the mold frame 800, the display module DM and the condensing sheet 500 may be spaced apart from each other.

The container 900 may be provided at the lowermost level of the display device 1000 and may be used to contain the backlight unit BLU.

The container 900 may include a bottom portion 910 and a plurality of sidewall portions 920 connected to the bottom portion 910. In exemplary embodiments, the light source LS may be provided on an inner side surface of one of the sidewall portions 920 of the container 900. The container 900 may consist of or include a rigid metallic material.

FIG. 3 is an enlarged sectional view of the display module DM of FIG. 2.

In exemplary embodiments, as shown in FIG. 3, the display unit 200 may be a liquid crystal display panel, for example. In an exemplary embodiment, the display unit 200 may include a first substrate SUB1 and a second substrate SUB2 facing each other, and a plurality of pixels (not shown) may be provided on the first substrate SUB1 and may be used to display an image using light provided from the backlight unit BLU, for example.

The display unit 200 may include an optically anisotropic material. In this case, the display unit 200 may exhibit specific phase retardation characteristics. In exemplary embodiments, the display unit 200 may include a liquid crystal layer LC interposed between the first substrate SUB1 and the second substrate SUB2. The liquid crystal layer LC may include a plurality of liquid crystal molecules LCM which are oriented in a specific direction.

The first substrate SUB1 may be provided on the first polarizing plate 310, and the second substrate SUB2 may be provided below the second polarizing plate 320. However, the invention is not limited thereto. In other exemplary embodiments, the display unit 200 may have a polarizing-plate-embedded structure, in which the first substrate SUB1 is provided below the first polarizing plate 310, for example.

The light-conversion structure 400 may be provided on the second polarizing plate 320. The light-conversion structure 400 may face the second substrate SUB2 with the second polarizing plate 320 interposed therebetween.

The light-conversion structure 400 may include a plurality of filters CF and a black matrix BM.

The filters CF may be spaced apart from each other and to face a plurality of pixel regions (not shown), in which pixels of the display unit 200 are provided. Depending on the energy of light to be incident into the second polarizing plate 320, the filters CF may change color of the incident light or transmit the incident light without a change in color. Each of the filters CF may include at least one light conversion particle.

The light conversion particle may be used to absorb at least a part of the incident light and then to emit light with a predetermined color or may be used to transmit at least a part of the incident light without any change in color. In the case where the incident light is energetic enough to cause excitation of the light conversion particle, the light conversion particle may absorb at least a part of the incident light and may become an excited state, and in this case, the light conversion particle may emit light of a predetermined color, when the light conversion particle returns to a lower energy state. By contrast, in the case where the energy of the incident light is insufficient to excite the light conversion particle, the incident light may pass through the filter CF without any change in color and may be emitted to the outside.

The color of light emitted from the filter CF may be determined by a particle size of the light conversion particle. In general, the larger the particle size, the longer the wavelength of the emitted light, and the smaller the particle size, the shorter the wavelength of the emitted light. In the illustrated exemplary embodiments, the light conversion particle may be a quantum dot (“QD”). The light to be emitted from the filter CF may be emitted in various directions.

The black matrix BM may be provided adjacent to the filter CF. The black matrix BM may include a light-blocking material. The black matrix BM may prevent light from being leaked through a region, other than the pixel region (not shown) for displaying an image or prevent a light leakage phenomenon from occurring. That is, the black matrix BM may be used to clarify boundaries between adjacent ones of the pixel regions.

In exemplary embodiments, when light generated in the backlight unit BLU passes through the first polarizing plate 310, the display unit 200, and the second polarizing plate 320 and is incident into the light-conversion structure 400, it may be possible to prevent the light from having a changed color. Thus, the color of the light generated in the backlight unit BLU may not be changed until the light is incident into the light-conversion structure 400.

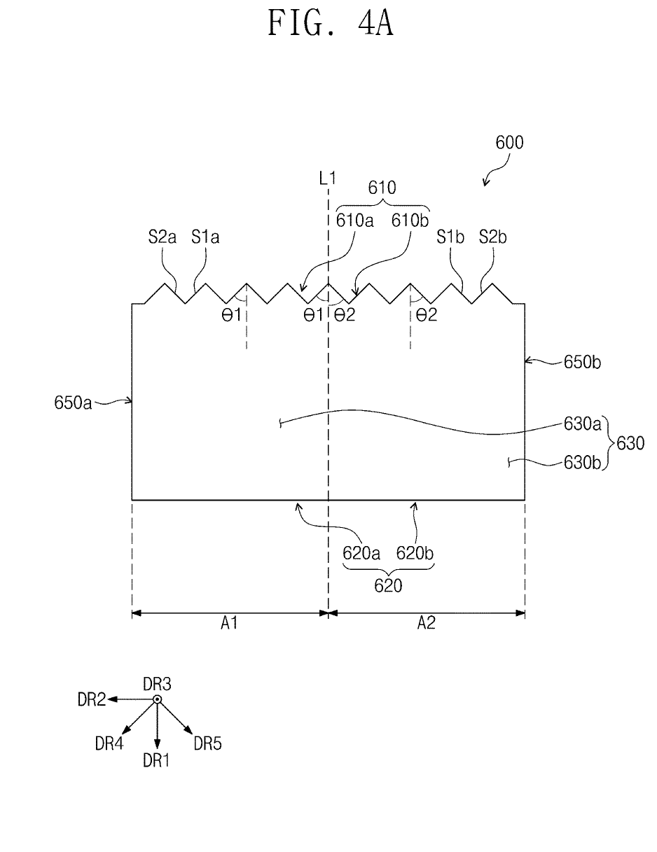

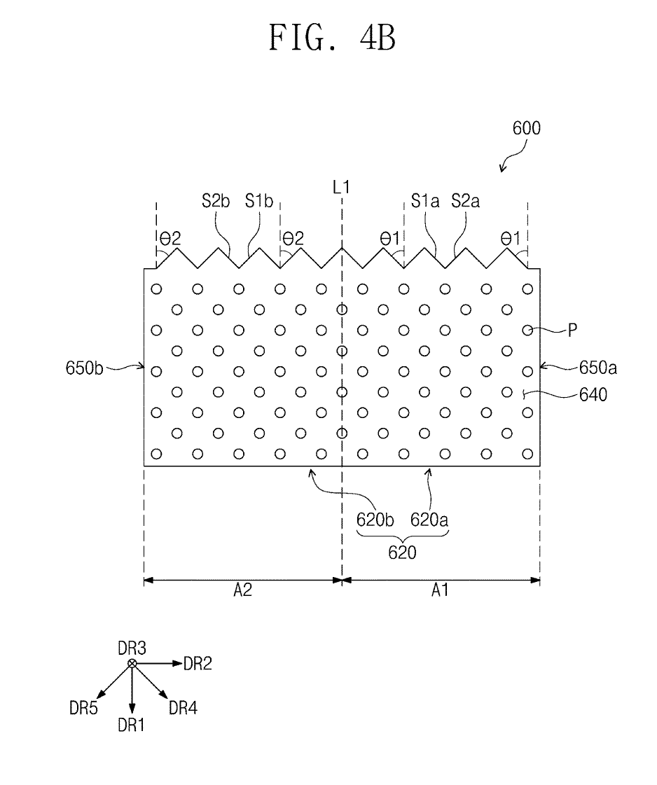

FIG. 4A is a top-plan view of a light guide plate 600 according to exemplary embodiments of the invention, and FIG. 4B is a bottom-plan view of a light guide plate 600 according to exemplary embodiments of the invention.

Referring to FIGS. 4A and 4B, in a plan view, the light guide plate 600 may include a first region A1 and a second region A2. When viewed in the third direction DR3, the first and second regions A1 and A2 may be two regions of the light guide plate 600, which are opposite to each other with respect to a virtual line L1 parallel to the first direction DR1.

In exemplary embodiments, the light guide plate 600 may include a light entering portion 610, an opposite portion 620, a light emitting portion 630, a bottom portion 640, a first side portion 650a, and a second side portion 650b.

The light entering portion 610 may be defined as one of the side surfaces of the light guide plate 600, which is located in the first direction DR1. The light entering portion 610 may receive the light provided from the light source LS. The light may be incident into the light guide plate 600 through the light entering portion 610.

The light entering portion 610 may include a first light entering portion 610a and a second light entering portion 610b. The first light entering portion 610a may be provided in the first region A1, and the second light entering portion 610b may be provided in the second region A2.

In the illustrated exemplary embodiments, the light entering portion 610 may have a zigzag shape, in a plan view. In an exemplary embodiment, the first light entering portion 610a may include a plurality of first light entering surfaces S1a and a plurality of first connection surfaces S2a, for example. In a plan view, the first light entering surfaces S1a may have a first angle θ1 relative to the first direction DR1. A direction parallel to the first light entering surfaces S1a in a plan view will be referred to as a fourth direction DR4.

Each of the first connection surfaces S2a may connect adjacent ones of the first light entering surfaces S1a to each other. The first light entering surfaces S1a and the first connection surfaces S2a may be connected to each other, thereby having a zigzag shape in a plan view.

A second light entering portion 610b may include a plurality of second light entering surfaces S1b and a plurality of second connection surfaces S2b. In a plan view, the second light entering surfaces S1b may have a second angle θ2 relative to the first direction DR1. A direction parallel to the second light entering surfaces S1b in a plan view will be referred to as a fifth direction DR5.

Each of the second connection surfaces S2b may connect adjacent ones of the second light entering surfaces S1b to each other. The second light entering surfaces S1b and the second connection surfaces S2b may be connected to each other, thereby having a zigzag shape in a plan view.

In an exemplary embodiment, the first light entering surfaces S1a and the second light entering surfaces S1b may be symmetric with reference to the virtual line L1. In an exemplary embodiment, the first angle θ1 may have an absolute value that is equal to that of the second angle θ2, for example. The absolute values of the first and second angles θ1 and θ2 may be less than 90°. In exemplary embodiments, the first angle θ1 may be +45° and the second angle θ2 may be −45°, for example. Here, each of the first and second angles θ1 and θ2 has a positive value, when it is measured in a clockwise direction from the first direction DR1 to the second direction DR2, and a negative value, when it is measured in a counterclockwise direction.

The opposite portion 620 may be defined as another of the side surfaces of the light guide plate 600, which is opposite to the light entering portion 610 in the first direction DR1. Although not shown, in other exemplary embodiments, a reflection element (not shown) may be provided on the opposite portion 620. The opposite portion 620 may include a first opposite portion 620a and a second opposite portion 620b corresponding to the first region A1 and the second region A2, respectively.

The light emitting portion 630 may be defined as the top surface of the light guide plate 600. The light, which is incident into the light guide plate 600 through the light entering portion 610, may be emitted toward the condensing sheet 500 (refer to FIGS. 1 and 2) through the light emitting portion 630.

The light emitting portion 630 may include a first light emitting portion 630a and a second light emitting portion 630b. The first light emitting portion 630a may be provided in the first region A1, and the second light emitting portion 630b may be provided in the second region A2.

The bottom portion 640 may be defined as a bottom surface of the light guide plate 600. In a third direction DR3, the bottom portion 640 may face the light emitting portion 630. Here, the third direction DR3 may be a direction that is perpendicular to both of the first and second directions DR1 and DR2 and may be used as a as a criterion for distinguishing top and bottom sides or upper and lower portions of each unit.

The first side portion 650a and the second side portion 650b may be two side surfaces of the light guide plate 600, which are opposite to each other in the second direction DR2. The first side portion 650a may be provided on the first region A1 to connect the first light entering portion 610a and the first light emitting portion 630a to each other. The second side portion 650b may be provided on the second region A2 to connect the second light entering portion 610b and the second light emitting portion 630b to each other.

As shown in FIGS. 4A and 4B, the light guide plate 600 may include a plurality of the dot patterns P provided on the bottom portion 640 of the light guide plate 600. The dot patterns P may be arranged in a matrix shape on the bottom portion 640 of the light guide plate 600.

FIG. 5 is a top-plan view illustrating a light source and a light guide plate according to exemplary embodiments of the invention, and FIG. 6 is a perspective view of the light source of FIG. 5.

Referring to FIGS. 5 and 6, the light source LS may include the plurality of light source units LSU and the light source substrate LSS.

The light source substrate LSS may be arranged in the second direction DR2 and may have a bar-shaped structure that is parallel to a plane defined by the first and second directions DR1 and DR2. The light source units LSU may be disposed (e.g., mounted) on the light source substrate LSS. Each of the light source units LSU may be provided in the form of a chip. The light source units LSU may be arranged in a row parallel to the second direction DR2. The light source units LSU may be provided adjacent to the light entering portion 610 (refer to FIG. 4A) of the light guide plate 600 and may face the light entering portion 610.

In an exemplary embodiment, the light source units LSU may include a plurality of first light source units LSU1 and a plurality of second light source units LSU2. The first light source units LSU1 may be provided in the first region A1, and the second light source units LSU2 may be provided in the second region A2. The first light source units LSU1 may be provided adjacent to the first light entering surfaces S1a (refer to FIG. 4A) of the first light entering portion 610a. The second light source units LSU2 may be provided adjacent to the second light entering surfaces S1b (refer to FIG. 4A) of the second light entering portion 610b.

In a plan view, the first light source units LSU1 may be tilted at the first angle θ1 relative to the first direction DR1. Thus, the first light source units LSU1 may be parallel to the first light entering surfaces S1a. That is, the first light source units LSU1 may be parallel to the fourth direction DR4.

In a plan view, the second light source units LSU2 may be tilted at the second angle θ2 relative to the first direction DR1. Thus, the second light source units LSU2 may be parallel to the second light entering surfaces S2a. In other words, the second light source units LSU2 may be parallel to the fifth direction DR5.

When measured on a plane defined by the first and directions DR1 and DR2, light propagating from the light source units LSU1 and LSU2 toward the light guide plate 600 may be inclined at an angle to a direction that is normal to light emitting surfaces of the light source units LSU1 and LSU2, and such an angle will be referred to as a declination angle (not shown). In the illustrated exemplary embodiments, the declination angle (not shown) may range from −90° to +90°.

A part of light provided from the first light source units LSU1 may be emitted in the direction normal to the light emitting surfaces thereof and may propagate toward the light guide plate 600, and hereinafter, such a part of the light will be referred to as a first light L1. An angle between a propagation direction of the first light L1 and the first direction DR1 will be referred to as a third angle θ3. Thus, the declination angle (not shown) of the first angle θ1 may be 0°.

A part of light provided from the second light source units LSU2 may be emitted in the direction normal to the light emitting surfaces thereof and may propagate toward the light guide plate 600, and hereinafter, such a part of the light will be referred to as a second light L2. An angle between a propagation direction of the second light L2 and the first direction DR1 will be referred to as a fourth angle θ4. Thus, the declination angle (not shown) of the second angle θ2 may be 0°.

The first light source units LSU1 and the second light source units LSU2 may be symmetric about the virtual line L1. In an exemplary embodiment, the third angle θ3 may have an absolute value that is equal to that of the fourth angle θ4, for example. The absolute values of the third and fourth angles θ3 and θ4 may be less than 90°. In exemplary embodiments, the third angle θ3 may be −45° and the fourth angle θ4 may be +45°.

However, the invention is not limited thereto. Although not shown, in other exemplary embodiments, the first and second light source units LSU1 and LSU2 may be arranged in an alternate manner, regardless of the first and second regions A1 and A2.

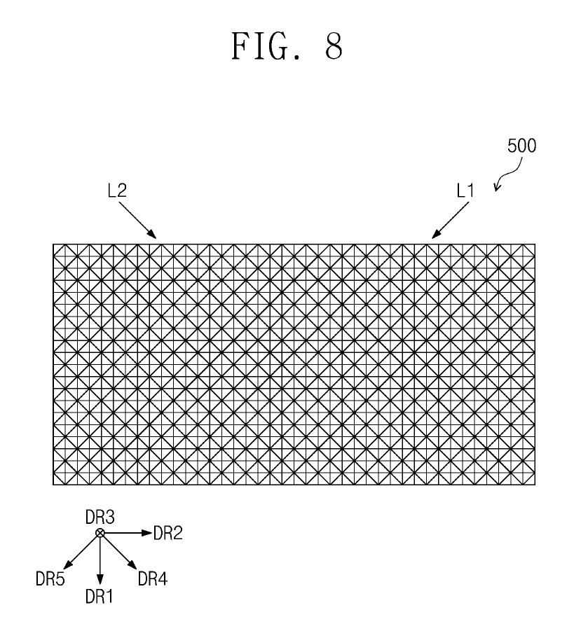

FIG. 7 is a perspective view illustrating a bottom side of a condensing sheet according to exemplary embodiments of the invention, and FIG. 8 is a bottom-plan view illustrating a condensing sheet according to exemplary embodiments of the invention.

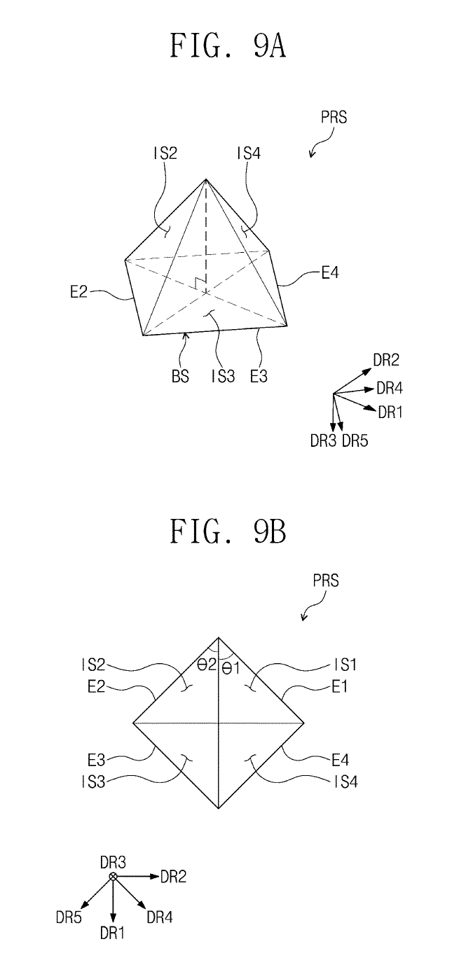

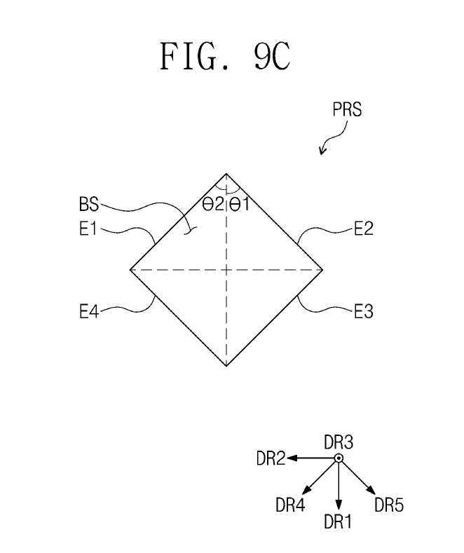

FIG. 9A is an enlarged perspective view of the reverse prism of FIG. 7, and FIG. 9B is a top-plan view of the reverse prism of FIG. 7. FIG. 9C is a bottom-plan view of the reverse prism of FIG. 7.

Referring to FIGS. 7 to 9C, the condensing sheet 500 may include a base substrate BL and a plurality of reverse prisms PRS. The reverse prisms PRS may be provided on a bottom surface of the base substrate BL.

In the illustrated exemplary embodiments, each of the reverse prisms PRS may be provided in the form of a quadrangular pyramid, on the bottom surface. However, the invention is not limited thereto. A shape of each of the reverse prisms PRS may be variously changed.

As shown in FIGS. 9A to 9C, each of the reverse prisms PRS may include a plurality of surfaces. In an exemplary embodiment, each of the reverse prisms PRS may include a base surface BS, which is parallel to the first and second directions DR1 and DR2, and first to fourth inclined surfaces IS1-IS4, each of which is inclined at an angle to the base surface BS, for example.

The base surface BS, which is used as a base of the quadrangular pyramid, may have a lozenge shape. The base surface BS may have first to fourth sides E1-E4. The first side E1 may connect the first inclined surface IS1 to the base surface BS. The second side E2 may connect the second inclined surface IS2 to the base surface BS. The third side E3 may connect the third inclined surface IS3 to the base surface BS. The fourth side E4 may connect the fourth inclined surface IS4 to the base surface BS.

The first side E1 and the third side E3 may face each other. The first side E1 and the third side E3 may be parallel to the fourth direction DR4. The second side E2 and the fourth side E4 may face each other. The second side E2 and the fourth side E4 may be parallel to the fifth direction DR5.

Referring to FIGS. 1 and 8 in conjunction with FIGS. 9A to 9C, the first light L1, which is a part of light propagating from the light guide plate 600 toward the condensing sheet 500, may be incident into the reverse prisms PRS. Here, an amount of the first light L1 to be incident into each of the surfaces of the reverse prisms PRS may be highest at the first inclined surface IS1. The first light L1 to be incident into the first inclined surface IS1 may be refracted by the reverse prism PRS and may be emitted toward the display module DM or in an upward direction.

An amount of the second light L2 to be incident into each of the surfaces of the reverse prisms PRS may be highest at the second inclined surface IS2. The second light L2 to be incident into the second inclined surface IS2 may be refracted by the reverse prism PRS and may be emitted toward the display module DM or in the upward direction.

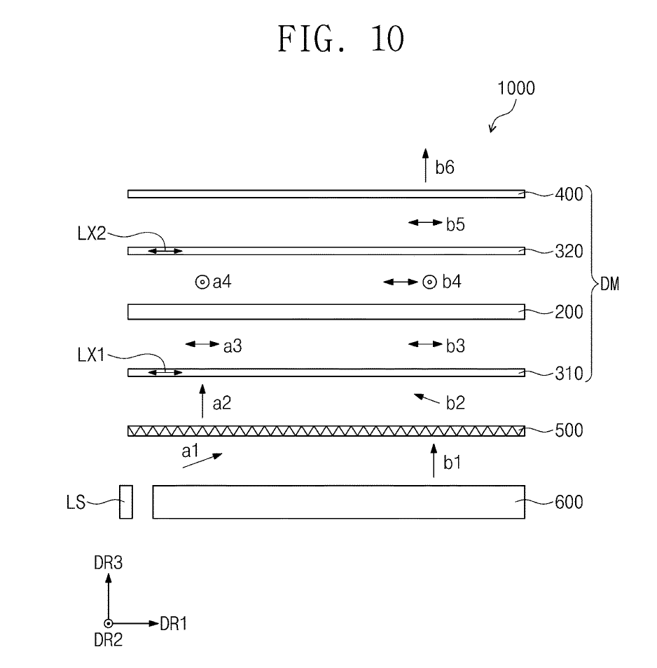

FIG. 10 is a diagram illustrating a light propagation state when a display device according to exemplary embodiments of the invention is in a dark state.

Referring to FIG. 10 in conjunction with FIGS. 2, 3, 4B, 5 and 6, in the case where the first and second lights L1 and L2, which are respectively emitted from the light source units LSU1 and LSU2 of the light source LS, propagate toward the light guide plate 600, the first and second lights L1 and L2 may be respectively tilted by third and fourth angles θ3 and θ4, which are determined by tilt directions DR4 and DR5 of the light source units LSU1 and LSU2, with respect to the first direction DR1 and then may propagate toward the light guide plate 600.

The first and second lights L1 and L2, which are incident into the light guide plate 600, may be reflected upward by the dot patterns P provided on the bottom portion 640 of the light guide plate 600 and may be incident into the condensing sheet 500 through the light emitting portion 630 (refer to a1 and b1). When the first and second lights L1 and L2 are incident into the condensing sheet 500, the first and second lights L1 and L2 may have different propagation angles with respect to the third direction DR3.

Hereinafter, an azimuthal angle is used to refer to an angle between a propagation direction of light, which is condensed by the condensing sheet 500 and is incident into the display module DM, and the third direction DR3. When the azimuthal angle is decreased, it may be possible to more effectively condense the light.

In exemplary embodiments, since the condensing sheet 500 has a plurality of reverse prisms, the larger an angle between a propagation direction of light, which propagates from the light emitting portion 630 toward the condensing sheet 500, and the third direction DR3, the smaller the azimuthal angle. Accordingly, when the angle between the propagation direction of such light and the third direction DR3 is increased, it may be possible to increase light condensing efficiency of the condensing sheet 500.

The first and second lights L1 and L2, which passed through the condensing sheet 500, may propagate toward the first polarizing plate 310 (e.g., refer to a2 and b2). Here, each of the first and second lights L1 and L2 incident into the first polarizing plate 310 may have components that are parallel and perpendicular to the first optic axis LX1. In exemplary embodiments, the first polarizing plate 310 may transmit the parallel component of each of the first and second lights L1 and L2 and to reflect or absorb the perpendicular component, and thus, the perpendicular component may be prevented from passing through the first polarizing plate 310. In other words, the first polarizing plate 310 may allow a linearly-polarized component of each of the first and second lights L1 and L2 (e.g., parallel to the first direction DR1) to pass therethrough (e.g., refer to a3 and b3).

The linearly-polarized components of the first and second lights L1 and L2 may be incident into the display unit 200. The liquid crystal molecules LCM of the display unit 200 may lead to a phase retardation of a component of each of the first and second lights L1 and L2 passing therethrough (e.g., refer to a4 and b4). In other words, polarization states of the first and second lights L1 and L2 may be changed.

The phase retardation R of the light passing through the liquid crystal layer LC may be given by a product of n and d (i.e., R=n×d), where n is a refractive index of the liquid crystal layer LC and d is a length of a light propagation path in the liquid crystal layer LC. The phase retardation may be changed depending on the orientation state of the liquid crystal molecules LCM of the liquid crystal layer LC.

In exemplary embodiments, the orientation of the liquid crystal molecules LCM may be controlled by adjusting the strength of an electric field applied to the display unit 200. That is, by adjusting the electric field applied to the display unit 200, it may be possible to control an amount of light passing through the display unit 200. In an exemplary embodiment, by adjusting the electric field applied to the display unit 200, the display device 1000 may become a bright or dark state, for example.

In an exemplary embodiment, in the case where the display device 1000 is in the bright state, the liquid crystal molecules LCM of the liquid crystal layer LC may have a first orientation in response to a first electric field applied thereto, for example.

In the case where light is linearly polarized in the first direction DR1 by the first polarizing plate 310, a phase of a component of the light may be retarded during passing through the liquid crystal molecules LCM. Here, a magnitude of the retarded phase will be referred to as a first phase retardation R1. The light with the first phase retardation R1 may have a polarization direction that is parallel to the second optic axis LX2 of the second polarizing plate 320. Accordingly, the light with the first phase retardation R1 may pass through the second polarizing plate 320 and may be incident into the light-conversion structure 400.

A wavelength of the light incident into the light-conversion structure 400 may be changed by light-conversion particles. In exemplary embodiments, the light-conversion particles may absorb light, which is incident in a specific direction, and to emit light in various directions. The light with the changed wavelength may be used to display an image.

In the case where, as shown in FIG. 10, the display device 1000 is in the dark state, the liquid crystal molecules LCM of the liquid crystal layer LC may have a second orientation in response to a second electric field applied thereto.

In the case where light is linearly polarized in the first direction DR1 by the first polarizing plate 310, a phase of a component of the light may be retarded during passing through the liquid crystal molecules LCM. Here, a magnitude of the retarded phase will be referred to as a second phase retardation R2 that is different from the first phase retardation R1. The light with the second phase retardation R2 may have a polarization direction that is perpendicular to the second optic axis LX2. Accordingly, the light with the second phase retardation R2 may be absorbed or reflected by the second polarizing plate 320 (e.g., refer to a4) and thus it may not pass through the second polarizing plate 320.

In exemplary embodiments, the strength of the second electric field and the second phase retardation R2 may be changed depending on directions of the optic axes and an initial orientation of the liquid crystal molecules LCM. For the sake of simplicity, the foregoing description has referred to an example of the exemplary embodiment in which the optic axes LX1 and LX2 are perpendicular to each other, the liquid crystal molecules LCM is initially oriented in a horizontal direction in a vertical orientation mode, and the strength of the second electric field and the second phase retardation are zero. However, the invention is not limited thereto. In other exemplary embodiments, the optic axes LX1 and LX2 may be parallel to each other or the liquid crystal molecules LCM may be oriented in a direction different from the horizontal direction, and moreover, the strength of the first electric field and the first phase retardation may be zero, for example.

When measured on the plane, light propagating from the first and second light source units LSU1 and LSU2 toward the light guide plate 600 may include a part that is not perpendicular to the light emitting surface, and such a part will be referred to as a third light (not shown). A declination angle (not shown) of the third light may be different from that of each of the first and second lights L1 and L2.

In general, when the third light passes through the liquid crystal layer LC of the display unit 200, a length of a propagation path of the third light in the liquid crystal layer LC may be different from those of the first and second lights L1 and L2. In an exemplary embodiment, in the case where the third light has a declination angle of +45° or −45°, a length of the light propagation path may be maximized, for example.

Furthermore, the larger an azimuthal angle (not shown) of the third light is, the longer a length of a propagation path of light passing through the liquid crystal layer LC is.

In the case where the display device 1000 is in the dark state, a magnitude of a retarded phase of the third light will be referred to as a third phase retardation R3. Since, in the liquid crystal layer LC, a light propagation path of the third light is different in those of the first and second lights L1 and L2, the third phase retardation R3 may be different from the second phase retardation R2. Thus, a polarization direction of the third light, which passed through the display unit 200, may be different from those of the first and second lights L1 and L2 (e.g., refer to b4). In other words, a part of the third light may pass through the second polarizing plate 320 (e.g., refer to b5). When the third light has a declination angle of +45° or −45°, an increase in the azimuthal angle of the third light may result in an increase of an amount of the third light passing through the second polarizing plate 320.

By contrast, in a case where the first and second light source units LSU1 and LSU2 are parallel to the second direction DR2 or the first and second lights L1 and L2 are parallel to the first direction DR1, at least a portion of the third light may pass through the second polarizing plate 320 and may be incident into the light-conversion structure 400. When a part of the third light incident into the light-conversion structure 400 has a large azimuthal angle, it may be absorbed by the light-conversion structure 400 and may be emitted in various directions with a changed wavelength. That is, even when the display device 1000 is in a dark state, a part of the light may be emitted in a frontal direction of the display device 1000 light (e.g., refer to b6), and this may lead to deterioration in a contrast ratio property of the display device. However, according to exemplary embodiments of the invention, each of the first and second light source units LSU1 and LSU2 may be parallel to the fourth and fifth directions DR4 and DR5, and the first and second inclined surfaces IS1 and IS2 of the reverse prism PRS of the condensing sheet 500 may be provided in such a way that the first and second sides E1 and E2 are parallel to the fourth and fifth directions DR4 and DR5, respectively. Accordingly, it may be possible to reduce an azimuthal angle of light having a longest light propagation path. That is, in the case where light propagates in the fourth and fifth directions DR4 and DR5, it may be possible to reduce an amount of the light passing through the second polarizing plate 320.

In the case of the display device according to exemplary embodiments of the invention, it may be possible to improve a contrast ratio property of the display device in the dark state.

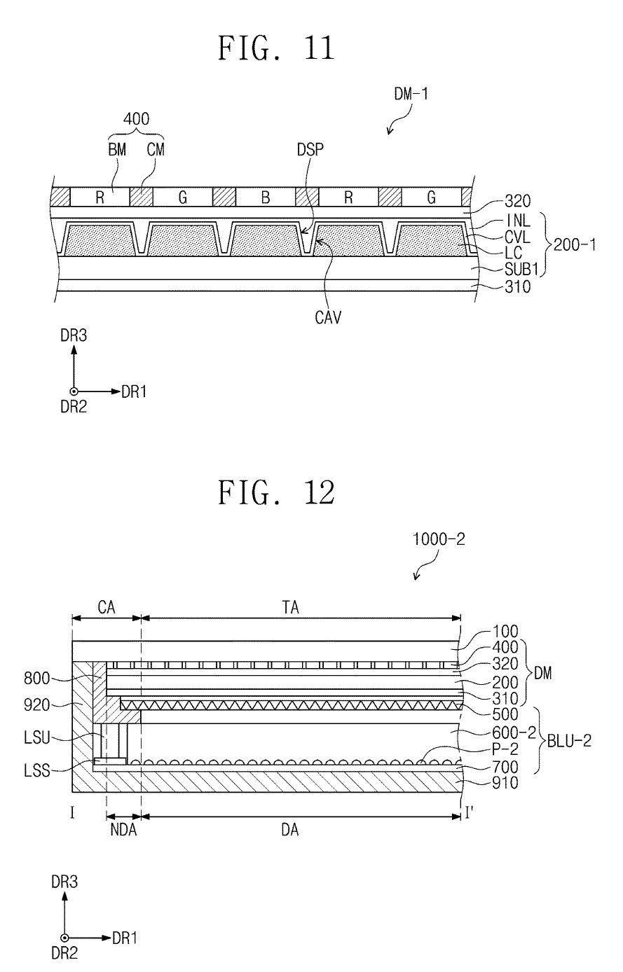

FIG. 11 is an enlarged view of a display module according to other exemplary embodiments of the invention. In the following description of FIGS. 11, a previously described element may be identified by a similar or identical reference number without repeating an overlapping description thereof, for the sake of brevity.

Referring to FIG. 11, a display unit 200-1 of a display module DM-1 may include a cover layer CVL and plurality of display devices DSP, in addition to the first substrate SUB1.

The first substrate SUB1 may be provided on the first polarizing plate 310 and may be used as a base substrate, allowing various devices to be disposed thereon. The first substrate SUB1 may include a highly transparent material, and this may make it possible to effectively transmit light, which is provided from the backlight unit BLU. In an exemplary embodiment, the first substrate SUB1 may be a transparent glass substrate, a transparent plastic substrate, or a transparent film, for example. In a plan view, a plurality of pixel regions (not shown) may be defined in the first substrate SUB1.

A cover layer CVL may be provided on the first substrate SUB1. The cover layer CVL may include lower portions, which are in contact with the first substrate SUB1, and upper portions, which are spaced apart from the first substrate SUB1 to define a plurality of cavities CAV. The cavities CAV may overlap the pixel regions.

The cavities CAV may be filled with the liquid crystal layer LC. The liquid crystal layer LC may include a plurality of liquid crystal molecules LCM (refer to FIG. 3). In exemplary embodiments, by adjusting a magnitude of an electric field applied to the display unit 200-1, it may be possible to control an amount of light passing through the cavities CAV, when light emitted from the backlight unit BLU (refer to FIG. 1) is incident into a display unit 200-1.

Hereinafter, each of the cavities CAV filled with the liquid crystal layer LC may be referred to as a display element DSP. The display element DSP may overlap the pixel region (not shown). Various elements may be used for the display element DSP, as long as the elements control an amount of light passing therethrough in response to an electrical signal applied thereto. In an exemplary embodiment, the display element DSP may be a liquid crystal capacitor, for example.

The display unit 200-1 may further include an insulating layer INL. The insulating layer INL may cover the cover layer CVL. The insulating layer INL may hermetically seal the cavities CAV.

The insulating layer INL may include at least one of transparent insulating materials. In exemplary embodiments, the insulating layer INL may include organic and/or inorganic materials. The insulating layer INL may include a plurality of organic and inorganic layers, which are stacked in an alternating manner.

The insulating layer INL may be an encapsulation layer for protecting the display element DSP from external harmful environment. In other exemplary embodiments, the insulating layer INL may include a flat top surface. The insulating layer INL may be variously realized, and the invention is not limited to a specific structure of the insulating layer INL.

The second polarizing plate 320 may be provided on the insulating layer INL. In exemplary embodiments, the second polarizing plate 320 may be directly disposed on the insulating layer INL. In other exemplary embodiments, the second polarizing plate 320 may be provided by a separate process and may be disposed on the insulating layer INL. In the case where the second polarizing plate 320 is provided by a separate process and is disposed on the display unit 200-1, an adhesive layer or an air layer may be provided between the second polarizing plate 320 and the display unit 200-1.

FIG. 12 is a sectional view of a display device according to other exemplary embodiments of the invention. In the following description of FIGS. 12, a previously described element may be identified by a similar or identical reference number without repeating an overlapping description thereof, for the sake of brevity.

Referring to FIG. 12, a plurality of dot patterns P-2 may be defined in a light guide plate 600-2 of a display device 1000-2. The dot patterns P-2 may be arranged in a matrix shape on a bottom portion of the light guide plate 600-2. The dot patterns P-2 may be recessed in an upward direction from the bottom portion of the light guide plate 600-2. That is, the dot patterns P-2 may have a concave structure.

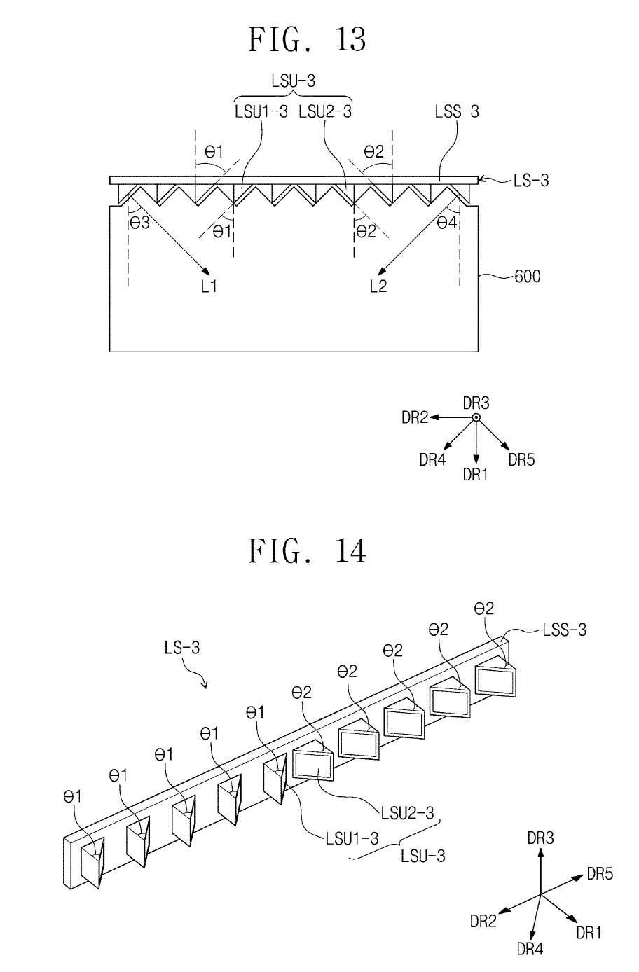

FIG. 13 is a top-plan view of a light source and a light guide plate according to other exemplary embodiments of the invention, and FIG. 14 is a perspective view of a light source of FIG. 13. In the following description of FIGS. 13 and 14, a previously described element may be identified by a similar or identical reference number without repeating an overlapping description thereof, for the sake of brevity.

Referring to FIGS. 13 and 14, a light source LS-3 may include a light source substrate LSS-3 extending in the second direction DR2 and having a bar shape parallel to the second direction DR2. A plurality of light source units LSU-3 may be disposed (e.g., mounted) on the light source substrate LSS-3. The light source units LSU-3 may be provided on a surface of the light source substrate LSS-3 facing the light entering portion 610 (refer to FIG. 4A) of the light guide plate 600.

In a plan view parallel to the first and second directions DR1 and DR2, each of first and second light source units LSU1-3 and LSU2-3 may be a right triangle shape. In the plan view, the first light source units LSU1-3 may be a right triangle shape of which hypotenuse is parallel to the fourth direction DR4. In the plan view, the second light source units LSU2-3 may be a right triangle shape of which hypotenuse is parallel to the fifth direction DR5.

Each of the first light source units LSU1-3 may include a light emitting surface that is substantially parallel to the fourth direction DR4. Each of the second light source units LSU2-3 may include a light emitting surface that is substantially parallel to the fifth direction DR5.

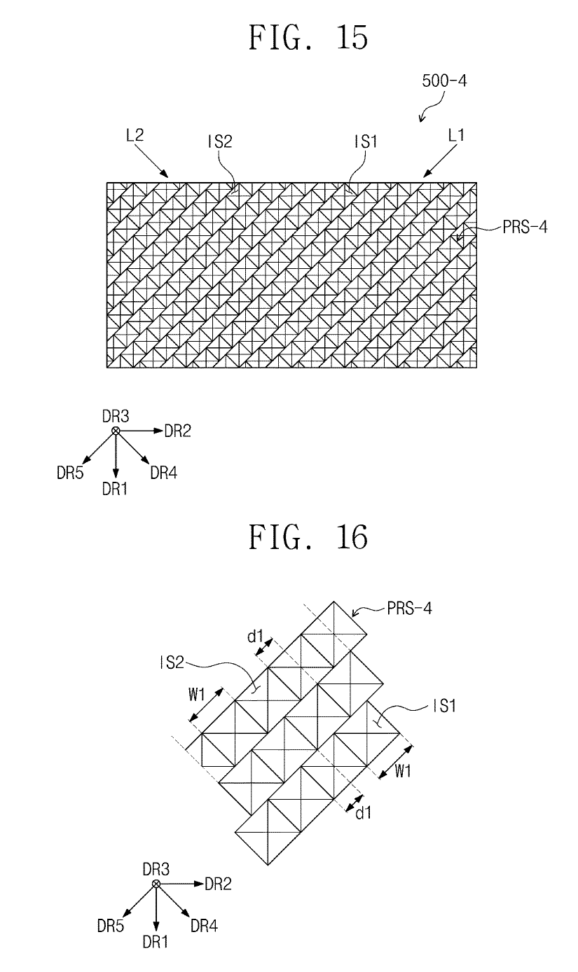

FIG. 15 is a bottom-plan view of a condensing sheet according to other exemplary embodiments of the invention, and FIG. 16 is an enlarged view of a condensing sheet of FIG. 15. In the following description of FIGS. 15 and 16, a previously described element may be identified by a similar or identical reference number without repeating an overlapping description thereof, for the sake of brevity.

Referring to FIGS. 15 and 16, a condensing sheet 500-4 may include a plurality of prism groups arranged in the fourth direction DR4. Each of the prism groups may include a plurality of reverse prisms PRS-4 which are arranged in a line in the fifth direction DR5.

In adjacent ones of the prism groups, the reverse prisms PRS-4 may be shifted from each other by a first distance d1. Here, the first distance d1 may be different from a first length W1 which is defined as a width of each of the reverse prism PRS-4 measured in the fifth direction DR5. This may make it possible to increase an effective incident area of the first inclined surface IS1 to the first light L1 to be provided in the fourth direction DR4.

In the illustrated exemplary embodiments, it may be possible to more effectively condense the first light L1 to be provided in the fourth direction DR4.

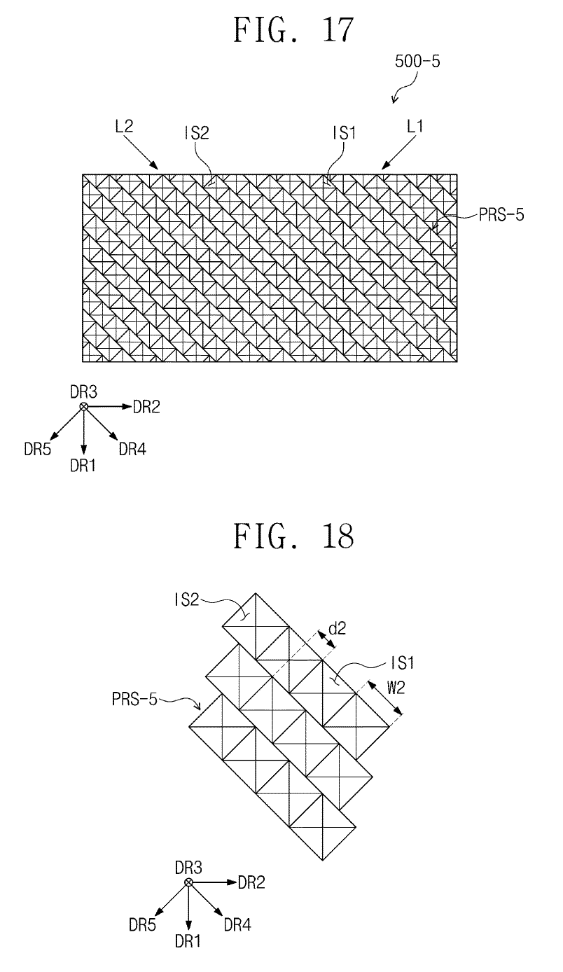

FIG. 17 is a bottom-plan view of a condensing sheet according to exemplary embodiments of the invention, and FIG. 18 is an enlarged view of a condensing sheet of FIG. 17. In the following description of FIGS. 17 and 18, a previously described element may be identified by a similar or identical reference number without repeating an overlapping description thereof, for the sake of brevity.

Referring to FIGS. 17 and 18, a condensing sheet 500-5 may include a plurality of prism groups arranged in the fifth direction DR5. Each of the prism groups may include a plurality of the reverse prisms PRS-5 which are arranged in a line in the fourth direction DR4.

In adjacent ones of the prism groups, the reverse prisms PRS-5 may be shifted from each other by a second distance d2. Here, the second distance d2 may be different from a second length W2, which is defined as a width of each of the reverse prism PRS-5 measured in the fourth direction DR4. This may make it possible to increase an effective incident area of the second inclined surface IS2 to the second light L2 to be provided in the fifth direction DR5.

In the illustrated exemplary embodiments, it may be possible to more effectively condense the second light L2 to be provided in the fifth direction DR5.

According to exemplary embodiments of the invention, it may be possible to improve a contrast ratio of a display device in a dark state.

While exemplary embodiments of the invention have been particularly shown and described, it will be understood by one of ordinary skill in the art that variations in form and detail may be made therein without departing from the spirit and scope of the attached claims.

What is claimed is:

1. A display device, comprising:
a display module which displays an image;
a light guide plate disposed below the display module;
a light source disposed at a side of the light guide plate in a first direction, the light source comprising a plurality of light source units arranged in a second direction crossing the first direction; and
a condensing sheet disposed between the display module and the light guide plate in a third direction which is perpendicular to the first direction and the second direction; the condensing sheet comprising a plurality of reverse prisms,
wherein the display module comprises:
a first polarizing plate disposed on the condensing sheet;
a second polarizing plate facing the first polarizing plate;
a display unit disposed between the first and second polarizing plates, the display unit comprising a liquid crystal layer; and
a light-conversion structure disposed on the second polarizing plate,
wherein the plurality of light source units comprise:
a plurality of first light source units disposed to be parallel to a fourth direction, which is at an angle of +45° to the first direction, when viewed on a plane defined by the first and second directions; and
a plurality of second light source units disposed to be parallel to a fifth direction, which is at an angle of −45° to the first direction, when viewed on the plane,
wherein each comprising the reverse prisms comprises a base surface, which is to be parallel to a plane defined by the first and second directions and comprises corners, each of which is defined by two sides parallel to the third and fourth directions, respectively, and
a plurality of inclined surfaces, which are inclined at an angle with reference to the base surface.

2. The display device of claim 1, wherein the light guide plate comprises:
a light entering portion disposed at a side of the light guide plate in the first direction to receive light from the light source;
an opposite portion facing the light entering portion in the first direction;
a light emitting portion which is parallel to the plane and emits light, which is incident from the light entering portion, in an upward direction; and
a bottom portion facing the light emitting portion and comprising a plurality of dot patterns.

3. The display device of claim 2, wherein the light entering portion comprises:
a plurality of first light entering surfaces parallel to the fourth direction; and
a plurality of second light entering surfaces parallel to the fifth direction.

4. The display device of claim 1, wherein the light guide plate comprises:
a first portion disposed at a side of the light guide plate in the second direction to receive light from the plurality of first light source units; and
a second portion disposed at another side of the light guide plate in the second direction to receive light from the plurality of second light source units.

5. The display device of claim 4, wherein, when viewed in the first direction, the first portion comprises a first light entering portion disposed at an off-centered region of the first portion and the second portion comprises a second light entering portion disposed at an off-centered region of the second portion.

6. The display device of claim 5, wherein the first light entering portion comprises:
a plurality of first light entering surfaces parallel to the fourth direction and face the plurality of first light source units; and
a plurality of first connection surfaces connecting the first light entering surfaces,
wherein the second light entering portion comprises:
a plurality of second light entering surfaces parallel to the fifth direction and face the plurality of second light source units; and
a plurality of second connection surfaces connecting the second light entering surfaces.

7. The display device of claim 1, wherein the light-conversion structure comprises a plurality of quantum dots.

8. The display device of claim 1, wherein the display unit further comprises:
a first substrate disposed on the first polarizing plate; and
a second substrate disposed below the second polarizing plate,
wherein the liquid crystal layer is interposed between the first and second substrates.

9. The display device of claim 1, wherein the display unit further comprises:
a first substrate disposed on the first polarizing plate; and
a cover layer disposed on the first substrate, the cover layer being slightly spaced apart from the first substrate to provide a plurality of cavities,
wherein the liquid crystal layer is disposed in each of the plurality of cavities.

10. The display device of claim 1, wherein the display unit further comprises:
a first substrate disposed on the first polarizing plate; and
a second substrate disposed on the second polarizing plate,
wherein the liquid crystal layer is interposed between the first substrate and the second polarizing plate.

11. The display device of claim 2, wherein the plurality of dot patterns has a convex shape protruding from the bottom portion.

12. The display device of claim 2, wherein the plurality of dot patterns has a concave shape recessed upward from the bottom portion.

13. The display device of claim 1, wherein the light source further comprises a light source substrate, on which the plurality of light source units is disposed.

14. The display device of claim 13, wherein the light source substrate extends in the second direction and is parallel to the plane defined by the first and second directions.

15. The display device of claim 1, wherein the reverse prisms comprise a first prism group of reverse prisms, which are arranged in a line in the fourth direction, and a second prism group of reverse prisms, which are adjacent to the first prism group in the fifth direction and are arranged in a line in the fourth direction,
the reverse prisms of the first prism group are shifted from the reverse prisms of the second prism group in the fourth direction by a first distance, and
the first distance is different from a length of the base surface measured in the fourth direction.

16. The display device of claim 1, wherein the reverse prisms comprises a third prism group of reverse prisms, which are arranged in a line in the fifth direction, and a fourth prism group of reverse prisms, which are adjacent to the third prism group in the fourth direction and are arranged in a line in the fifth direction,
the reverse prisms of the third prism group are shifted from the reverse prisms of the fourth prism group in the fifth direction by a second distance, and
the second distance is different from a length of the base surface measured in the fifth direction.

17. A display device, comprising:
a display module which displays an image;
a light guide plate disposed below the display module;
a light source which is disposed at a side of the light guide plate in a first direction, the light source extending in a second direction crossing the first direction and providing light to the light guide plate; and
a condensing sheet disposed between the display module and the light guide plate in a third direction which is perpendicular to the first direction and the second direction; the condensing sheet comprising a plurality of reverse prisms,
wherein the display module comprises:
a display unit including a liquid crystal layer;
a light-conversion structure disposed on the display unit to change a wavelength of light, which is incident from the display unit;
a first polarizing plate disposed between the display unit and the condensing sheet; and
a second polarizing plate disposed between the display unit and the light-conversion structure,
wherein the light source comprises first light source units, which are tilted in a fourth direction, on a plane defined by the first and second directions, the fourth direction being a direction between the first and second directions,
each of the reverse prisms comprises a base surface, which is parallel to the plane, and a plurality of inclined surfaces, which are inclined at an angle to the base surface, and
the base surface comprises sides parallel to the fourth direction.

18. The display device of claim 17, wherein the fourth direction is at an angle of 45° or −45° relative to the first direction.

19. The display device of claim 17, wherein the light guide plate comprises:
a light entering portion which is disposed at a side of the light guide plate in the first direction and receives light from the light source; and
an opposite portion facing the light entering portion in the first direction;
a light emitting portion which is parallel to the plane and emits light, which is incident from the light entering portion, in an upward direction; and
a bottom portion facing the light emitting portion and comprising a plurality of dot patterns.

20. The display device of claim 17, wherein the light-conversion structure comprises a plurality of quantum dots.
